(19) United States
(12) Patent Application Publication
(10) Pub. No.: US 2003/0131927 A1
(43) Pub. Date: Jul. 17, 2003

(54) Mold transfer system

(76) Inventors: Johnie F. Hatcher, La Habra, CA (US); Brian S. Lee, Montebello, CA (US)

Correspondence Address: Karin E. Peterka, Esq., Buchalter, Nemer, Fields & Younger, Suite 2400, 601 South Figueroa Street, Los Angeles, CA, 90017-5704, US

(21) Appl. No.: 10/342,700

(22) Filed: Jan. 15, 2003

Related U.S. Application Data
(60) Provisional application No. 60/349,744, filed on Jan. 17, 2002.

(51) Int. Cl. B44C 1/165

(52) U.S. Cl. 156/230; 156/540; 427/146; 428/914

(57) ABSTRACT

The present invention is directed to a method and system for transferring a molded element onto a textile material comprising the steps of: (a) heating a liquid polymeric material inside a mold to transform the liquid polymeric material from a liquid to a gel to form a molded element; (b) applying the molded element in the mold to the textile material with heat and pressure in order to transfer the molded element from the mold onto the textile material; and, (c) cooling the molded element on the textile material by applying cold and pressure to the molded element in the mold in order to adhere the molded element to the textile material.

### CROSS-REFERENCE TO RELATED APPLICATION

This application is a continuation-in-part of U.S. provisional patent application serial No. 60/349,744, filed Jan. 17, 2002, titled “Mold Transfer System”, currently pending.

### BACKGROUND OF THE INVENTION

The present invention is directed to a unique, novel, and nonobvious mold transfer system that makes a mold transfer and application at the same time. In particular, the present invention is directed to a unique new textile application process that creates three-dimensional images and special effects that adhere directly to textiles, fabrics, or garments, preferably made of cotton, poly-cottons, natural fibers, synthetics, and other natural materials.

Known dimensional transfer systems include sewing images or special effects to a garment or fabric. These systems are time consuming and may not give the desired look. Other known dimensional transfer systems include fabric welding which is very expensive and requires the use of expensive equipment. Other known dimensional transfer systems include mold transfer systems that use three different bases, including clear, color, and special effects. Such three base systems are expensive and difficult to inventory.

Accordingly, there is a need for a new and improved system for transferring and applying a three-dimensional molded element or image to a textile material or fabric which overcomes and avoids the problems associated with known dimensional transfer systems.

### SUMMARY OF THE INVENTION

The present invention satisfies these needs as well as provides a unique and advantageous mold transfer system for transferring and applying a three-dimensional molded element or image to a textile material or fabric. None of the known dimensional transfer systems provides all of the numerous advantages of the present invention.

In contrast to known transfer systems, the mold transfer system of the present invention provides the following advantages:

It is a less expensive system. It simulates more complicated fabric welding and mold systems, at less than 10% and 20%, respectively, of the capital costs. Less number of molds are needed in the method of the present invention than known methods because the production process is faster and molds can be re-used quickly.

The mold transfer system of the present invention is flexible, simple to use, and easy to apply.

Unlike other more complicated welding and mold transfer systems, the mold transfer system of the present invention is designed and priced for use by all size textile decorating shops, including both large and small shops. The flexibility of the present system will accommodate any decorating need, whether by a small custom shop or by a large production printer.

The mold transfer system of the present invention uses a unique liquid polymeric material, and preferably, a plastisol mold transfer compound. The plastisol mold transfer compound used in the present invention is a single base system that can be used as a clear base or as a mixing base for color concentrates, a color mix system, or special effect additives. The use of a one base system instead of the known three base system reduces the overall cost of the system and is easier to inventory. In addition, the mold transfer compound can be used with a color mix system to quickly simulate over one thousand (1000) colors. The system brings new dimension to garment and fabric decorating. The easy to use system creates a wide range of unique three-dimensional images and stunning special effects. Unlimited decorating opportunities are created with the present system, all at a fraction of the cost of other more complicated welding systems.

The mold transfer system also uses an industrial hot plate, a heat transfer machine, and a cool press machine, as more fully described below, and does not require the use of a drying machine. The combination of the plastisol mold transfer compound, the industrial hot plate, the heat transfer machine, and the cool press machine, and the time, temperature, and pressure application relationship makes the system of the present invention a fast, efficient, and user friendly system.

In one version of the present invention a method for transferring a molded element onto a textile material is provided comprising the steps of: (a) heating a liquid polymeric material inside a mold at an effective temperature and for an effective time period to transform the liquid polymeric material from a liquid to a gel to form a molded element; (b) applying the molded element in the mold to the textile material with heat and pressure at an effective temperature and pressure for an effective time period in order to transfer the molded element from the mold onto the textile material; and, (c) cooling the molded element on the textile material by applying cold and pressure at an effective temperature and pressure for an effective time period to the molded element in the mold in order to adhere the molded element to the textile material. The method of the present invention may further comprise the step of cooling the molded element in the mold on a cold surface to an ambient temperature after step (a) and before step (b).

Preferably, the liquid polymeric material comprises a plastisol compound comprising polyvinyl chloride resin, plasticizers such as phthalate esters and/or non-phthalate esters, and additives such as heat stabilizers and viscosity modifiers.

In another version of the present invention, the method comprises the steps of:

(a) heating a liquid polymeric material inside a mold at an effective temperature and for an effective time period to transform the liquid polymeric material from a liquid to a gel to form a molded element; (b) cooling the molded element in the mold on a cold surface to an ambient temperature; ©) adding another liquid polymeric material to the molded element in the mold; (d) repeating step (a); (e) applying the molded element in the mold to the textile material with heat and pressure at an effective temperature and pressure for an effective time period in order to transfer the molded element from the mold onto the textile material; and, (f) cooling the molded element on the textile material by applying cold and pressure at an effective temperature and pressure for an effective time period to the molded element in the mold in order to adhere the molded element to the textile material.

In another version of the invention, a method for transferring a three-dimensional image onto a fabric is provided comprising the steps of: (a) providing a hollow medium having an interior side and an exterior side; (b) filling the interior side of the hollow medium with a liquid polymeric material; (c) heating the liquid polymeric material inside the hollow medium to an effective temperature and for an effective time period to gel the liquid polymeric material and to form the three-dimensional image; (d) applying the three-dimensional image in the hollow medium to the fabric with heat and pressure at an effective temperature and pressure for an effective time period to transfer the three-dimensional image from the hollow medium onto the fabric; and, (e) cooling the three-dimensional image on the fabric by applying cold and pressure at an effective temperature and pressure for an effective time period to adhere the three-dimensional image in the hollow medium to the fabric.

In another version of the invention, a system for transferring a molded image onto a textile material is provided comprising the steps of: (a) heating on a heated surface a liquid polymeric material inside a mold to a temperature of at least 400 degrees F. and for an effective time period to transform the liquid polymeric material from a liquid to a gel to form a molded image; (b) removing the molded image in the mold from the heated surface and cooling on a cold surface to an ambient temperature; (c) applying the molded image to the textile material with a heat transfer apparatus at a temperature of at least 400 degrees F. and at an effective pressure for an effective time period to transfer the molded image from the mold onto the textile material; and, (d) cooling the molded image on the textile material with a cool press apparatus at an effective temperature and pressure for an effective time period to adhere the molded image in the mold to the textile material.

These and other features, aspects and advantages of the present invention will become better understood from the following description and appended claims.

### DETAILED DESCRIPTION

The present invention is directed to a unique mold transfer method and system that makes a mold transfer and application at the same time and that utilizes both a heat transfer apparatus and a cold press apparatus. In particular, the present invention is directed to a unique new textile application and transfer process that creates three-dimensional images and special effects that adhere directly to a textile material or fabric. Preferably the textile material or fabric is in the form of apparel or garments, preferably made of cotton, poly-cottons, natural fibers, synthetics, and other natural materials. However, the method or system of the present invention can also be used with bedding materials, such as sheets, pillow cases, and bedspreads; bathroom materials, such as towels; and other textile materials.

In one version of the present invention, a method for transferring a molded element onto a textile material is provided. The first step of the method is heating a first liquid polymeric material inside a mold or hollow medium at an effective temperature and for an effective time period to transform the liquid polymeric material from a liquid to a gel or semi-solid to form a molded element. The first liquid polymeric material is poured or placed into a mold or hollow medium. The liquid polymeric material preferably comprises a plastisol mold transfer compound. Preferably, the plastisol compound comprises from about 48% to about 68% polyvinyl chloride resin, from about 30% to about 50% plasticizers, and from about 1% to about 10% specialty additives, so that the total of all elements equals 100%. More preferably, the plastisol compound comprises about 58% polyvinyl chloride resin, about 40% plasticizers, and about 2% specialty additives. Preferably, the plasticizers comprise phthalate esters, non-phthalate esters, or a combination of phthalate esters and non-phthalate esters. Preferably, the specialty additives comprise heat stabilizers, such as barium zinc, and also comprise viscosity modifiers, such as fumed silica. The heat stabilizers keep the plastisol from turning color when it is heated, such as preventing a clear compound from turning brownish or discoloring. Preferably, when the liquid polymeric material used in the present invention is converted from a liquid state to a gel or semi-solid state, the gel or semi-solid state should have a hardness of about 50 shore to about 80 shore. The preferred liquid polymeric material or plastisol used with the present invention is obtained from International Coatings Company located in Cerritos, Calif. The plastisol mold transfer compound used in the present invention is a single base system that can be used as a clear base or as a mixing base for color concentrates, a color mix system, or special effect additives. The use of a one base system instead of the known three base system reduces the overall cost of the system and is easier to inventory. In addition, the mold transfer compound can be used with a color mix system to quickly simulate over one thousand (1000) colors. The preferred color mix plastisol compounds used with the present invention include fifteen (15) primary mixing colors including black and white, and allow one to simulate colors from a palette of over one thousand (1,000) colors. The preferred plastisol compounds are either lead-free or contain less than 0.025% lead. The preferred plastisol compounds can be used on light or dark 100% cotton fabrics, 50/50 polyester/cotton blends, and other materials. Formulations of over one thousand (1000) colors may be prepared with the plastisol compounds, and such formulations may be derived from ink management software programs typically available to those skilled in the art. A user of the present invention may reference a desired color in a color mix software guide, mix the appropriate primary colors using the formula from the guide, and use in the present system.

The plastisol compounds of the present invention should be fused with an appropriate heat source to become wash fast. The optimum time and temperature cycle will vary with the amount of plastisol deposited, and the fabric and type of heat source used.

The plastisol compound is preferably loaded into a squeeze bottle or another pouring vessel, or can be applied with a squeegee. A predetermined amount of the plastisol is then squeezed from the squeeze bottle or pouring vessel into a mold, a photo etch, an engraving, an embossing, a die or another hollow medium. The mold or hollow medium has an interior side and an exterior side. The interior side of the mold may have one or more channels for holding one or more colors separately. The interior side of the mold is filled with a predetermined amount of plastisol. The mold or hollow medium is preferably made of metal, such as magnesium or aluminum. The preferred mold or hollow medium used with the method of the present invention can be obtained from Owosso Inc. located in Owosso, Mich.

The exterior side of the filled mold is then placed on a heated surface or hot plate. Preferably, the hot plate is an industrial hot plate, such as model MAHP 1520, obtained from Insta Graphic Systems, Inc. of Cerritos, Calif. However, other industrial or non-industrial hot plates familiar to those skilled in the art of mold transfers may be used. The preferred hot plate delivers more than 1200 watts of heating power, and more preferably, delivers 1700 watts of heating power, 120 volts, 14.17 amps, delivered through heating elements capable of quickly reaching and holding a temperature of at least 400 degrees F. (Fahrenheit). Temperature of a preferred hot plate can be controlled in a range from about 100 degrees F. to about 450 degrees F. The use of a hot plate capable of achieving higher temperatures, such as temperatures of at least 400 degrees F., speeds up the process of the present invention. The heating elements are cast into a grill plate, resulting in exceptionally even heat distribution and a long life expectancy. The grill plate has a minimum grill size of 10 inches wide by 10 inches long, and preferably has a grill size of 15 inches wide by 20 inches long. The approximate dimensions of a preferred Insta Graphic Systems, Inc. MAHP 1520 machine that may be used are 22½ inches long by 17½ inches wide and having a height of 7¼ inches. The industrial hot plate used in the system of the present invention can process multiple molds quickly and precisely for high production runs. The machine has an on/off switch and a safety bar around the heating surface.

For the method of the present invention, prior to placing the exterior side of the filled mold on the hot plate, the temperature of the industrial hot plate should be set to a temperature of at least 400 degrees F., and preferably in the range of 400 degrees F. to about 450 degrees F., and most preferably at 425 degrees F. Depending on the size of the molds, dies, engravings, etchings or hollow mediums, one or more, and typically four to eight filled molds, may be heated on the hot plate simultaneously. The exterior side of the filled mold is placed on the hot plate and heated to at least 400 degrees F., and preferably to 425 degrees F., for a time period of from about 10 seconds to about 30 seconds, and preferably from about 15 seconds to about 20 seconds, to transform the liquid polymeric material from a liquid to a gel or semi-solid to form a three-dimensional molded element or molded image. The thicker and larger the mold, the longer it takes for the liquid polymeric material to gel. A desired gel or semi-solid state is achieved when the clear liquid polymeric material or plastisol obtains a milky, non-wet look around the edges of the material in the mold. The inside area of the mold channels or areas covered by the plastisol should look slightly wet. When the liquid polymeric material or plastisol reaches the desired gel consistency, the mold is removed from the hot plate, preferably with protective gloves.

If only one color is used in the method of the present invention, the next step in the method is the heat transfer step. This step involves applying the molded element in the mold to a textile material or fabric with heat and pressure in order to transfer the molded element or image from the mold onto the textile material. Optionally, if a user does not use protective gloves or another protective material to remove the molded element from the hot plate, the molded element or gelled polymeric material may be cooled to ambient or room temperature before applying and transferring it to the textile material with heat and pressure.

If more than one color is used in the method of the present invention, the next step in the method is to cool the molded element in the mold to an ambient temperature or room temperature. The molded element may be cooled by preferably placing the molded element in the mold on a cooled surface, such as a metal or aluminum sheet placed over ice, or a cool down tray, or metal sheets with ice in between the sheets. Once the mold is cool to the touch, any molded element or gelled polymeric material applied outside the desired area of the mold can be removed using a sharp knife or blade. Once the molded element and mold are sufficiently cooled to ambient temperature, another liquid polymeric material or color or special effect may be added to another area or channel in the interior of the mold separate from the first polymeric material. After the second liquid polymeric material or color is added, the first step of the process is repeated, and the mold is again heated on the hot plate to transform the second liquid polymeric material from a liquid to a gel or semi-solid. The first heating step on the hot plate is repeated at the same temperature and time described above for each new color added. The cooling step on the cooled surface is repeated when a new color is to be added to one or more existing colors.

The heating step on the hot plate is then repeated when a new color is added to one or more existing colors. Depending on the style and size of the mold, the mold may contain numerous colors. However, the typical mold can hold 2-3 different colors. Once all of the colors have been added to the mold and gelled, the molded element or gelled polymeric material in the mold can then be applied to the textile, fabric or garment.

For the heat transfer step of applying the molded element in the mold to a textile material or fabric with heat and pressure in the present invention, a heat transfer apparatus is used. Preferably, the heat transfer apparatus used in the present invention is a heat transfer machine, such as model number MS203Z, obtained from Insta Graphic Systems, Inc. located in Cerritos, California. However, other suitable heat transfer or hot press machines familiar to those skilled in the art of mold transfers may also be used. The preferred heat transfer machine allows for quick, easy, and precise application of the mold to the textile material or fabric. The non-floating head or upper heat platen provides even pressure to assure proper transfer and substantial adhesion and full access to the lower platen. Preferably, the lower platen has a minimum size of 5 inches wide by 5 inches long, and more preferably, has a size of 15 inches wide by 15 inches long. The heat transfer machine may also have a silicone rubber pad that can be shaped and attached to the lower platen with a silicone glue or other attachment means. The silicone rubber pad may have a thickness of from about ⅛ inch to about ⅜ inch, a density of 0.017 pound per inch to 0.026 pound per inch, a compress force deflection (CFD) of 6 pounds per square inch (psi) to 18 pounds per square inch (psi), a tensile strength of 50 psi to 100 psi, elongation of 150% to 200%, a maximum compression set of 25% to 30%, and a functional temperature range of −65 degrees F. to 480 degrees F. The heat transfer machine may also include separate garment placement platens. The garment placement platens are preferably made of a metal such as aluminum and have a thickness of about ⅜ inch to about ¼ inch, so that they do not bend.

The heat transfer machine preferably provides at least 1200 watts of heating power, and more preferably provides 1500 watts of heating power, 115 volts to 120 volts, 14.6 amps, and an integrated digital temperature and time controller. The heat transfer machine is preferably capable of reaching and holding a temperature of at least 400 degrees F., and preferably 425 degrees F. Temperature of the heat transfer machine can be controlled in a range from 100 degrees F. to 480 degrees F. The heat transfer machine has a cast-in tubular heating element that provides reliable, even heating. The approximate dimensions of a preferred Insta Graphic Systems, Inc. MS203Z machine are 37 inches in width by 25 inches in length and 47 inches in depth.

In the heat transfer step, the textile material or fabric is aligned on the lower platen of the heat transfer machine, preferably over the silicone rubber pad. The mold is placed interior side down or face down on the fabric and preferably centered over the silicone pad. For the best results, the textile material should be pulled over the lower platen or a garment placement platen to prevent making an image of the mold on the back or front sides of the textile material, depending on the application size of the mold. If the mold is being cooled because protective gloves or another protective material are not being used, place the mold, once it is cool enough to handle, on the desired area of the textile material with the molded element or gelled polymeric material side of the mold facing down and in contact with the textile material. A silicone slip sheet may be placed over the exterior side of the mold to help protect the upper heat platen from being scratched and to prevent the back of the mold from sticking to the upper heat platen. Once the mold is lined up and the slip sheet is in place, the heat transfer upper platen may be lowered down into contact with the exterior side of the mold. Prior to placing the textile material and molded element in the mold on the lower platen, the temperature of the heat transfer press should be set to a temperature of at least 400 degrees F., and preferably in the range of 400 degrees F. to about 440 degrees F., and most preferably at 425 degrees F.

The pressure is applied to the textile material by lowering the upper heat platen onto the mold and textile material. The pressure of the heat transfer machine applied is preferably from about 20 psi to about 50 psi. However, the pressure may be adjusted and is dependent on the thickness of the textile material used. The thicker the textile material, the more pressure is applied to the mold and textile material. The thinner the textile material, the less pressure is applied to the mold and textile material.

In the heat transfer step, the heat and pressure are applied for a time period of about 10 seconds to about 30 seconds, and preferably for a time period of about 15 seconds to about 20 seconds. The heat application time depends on the temperature used. The higher the temperature, the faster the application time. The heat and pressure are applied to the molded element or three-dimensional element in the mold in order to transfer the molded element from the mold onto the textile material or fabric. The pressure and heat pushes and transfers the gelled polymeric material or molded element into the textile material and partially attaches the molded element to the textile material. The heat transfer apparatus acts to heat and cure the polymeric material to faciliate the transfer of the polymeric material from the interior of the mold onto the textile material.

The next step of the method of the present invention is the cool press step. This step involves cooling the molded element on the textile material by applying cold and pressure at an effective temperature and pressure for an effective time period to the molded element in the mold in order to adhere the molded element to the textile material. After the molded element is transferred or applied to the textile material in the heat transfer step, the textile material is carefully removed from the heat transfer machine and placed on a cool press apparatus or machine. The cool press rapidly takes the heat away from the heated mold while it is still on the textile material. By applying pressure to the mold and taking heat away from the mold, the polymeric material can more easily and quickly completely adhere to the textile material.

Preferably, the cool press machine used with the method or system of the present invention is a mechanical, manual, ambient cool press machine, such as model number MACP1515, obtained from Insta Graphic Systems, Inc. of Cerritos, Calif. Electrical power is not required with the preferred cool press machine. However, other suitable cool press machines familiar to those skilled in the art of mold transfers may be used. The application of cold and pressure to the textile material is accomplished with the cool press machine. The cool press machine has a fixed head or upper platen with a height and pressure adjustment and is capable of providing even pressure of about 20 psi to about 50 psi across a minimum 5 inch wide by 5 inch long lower platen. The cool press machine may be used with or without a silicone rubber pad. The fixed head or upper platen may contain or accommodate ice or dry ice in a contained area or tray. The approximate dimensions of a preferred InstaGraphic Systems, Inc. MACP1515 machine are 20 inches in depth by 15 inches in width by 10 inches in length. The cool press machine is critical to the system of the present invention. The cool press machine provides a quick cool down and evenly distributed pressure, both critical for superior adhesion of the molded element to the textile material. The swing away head of the cool press machine allows for quick and easy loading, and can be easily adjusted to accommodate varying mold and silicone pad heights. The head has been specially designed to accommodate dry ice or ice for quick cooling and high production runs.

The temperature of the cool press should preferably be at ambient temperature or less than ambient temperature. If ice or dry ice is used, the temperature of the cool press should preferably be less than 32 degrees F. The cool press step is designed to cool the molded element in the mold quickly and lower the temperature of the molded element and the mold down to ambient temperature or lower.

The pressure is applied to the textile material by lowering the upper platen of the cool press onto the mold and textile material. The pressure of the cool press machine applied is preferably from about 20 psi to about 50 psi. However, the pressure may be adjusted and is dependent on the thickness of the textile material used. The thicker the textile material, the more pressure is applied to the mold and textile material. The thinner the textile material, the less pressure is applied to the mold and textile material.

In the cool press step, the cold and pressure are applied for a time period of about 10 seconds to about 30 seconds, and preferably for a time period of about 10 seconds to about 20 seconds. The cold application time depends on the temperature used. The lower the temperature, the faster the application time. The cold and pressure are applied to the molded element or three-dimensional element in the mold in order to completely adhere the molded element or three-dimensional image from the mold onto the textile material or fabric.

After the effective temperature and pressure are applied to the molded element on the textile material for an effective time period, the textile material is removed from the cold press machine, and the mold is removed from the textile material, preferably by manually peeling the mold away from the textile material or fabric. The typical time it takes to conduct the method of the present invention with a single color is about one minute. If more than one mold is used at a time, typically 3-8 molds can be applied and transferred to textile materials in a very short period of time. The typical time it takes to conduct the method of the present invention with a mold containing multiple colors may be in the range of 2-3 minutes.

### EXAMPLE I

The invention will be further explained by the following example which is intended to be nonlimiting. In one version of the present invention, the following steps were performed:

Load the plastisol mold transfer compound into an interior portion of a mold using a squeeze bottle. Squeeze the plastisol mold transfer compound into the appropriate channel of the mold.

Place the mold containing the plastisol mold transfer compound onto an Insta Graphic Systems, Inc. MAHP 1520 industrial hot plate set at 425 degrees F. and let it semi-solidify into a gel for about 15 to 20 seconds. Proper gel is achieved when the mold compound obtains a milky, non-wet look around the edges. The inside area of the mold channels should look slightly wet. Once the plastisol is properly gelled, remove the mold from the hot plate using appropriate protective gloves and place on a cool-down plate, preferably made of metal. Once the mold is cool to the touch or cooled to ambient temperature, remove any mold compound applied outside the desired area of the mold by cutting and removing with a sharp knife. Carefully cut and pick the material from the mold. For a multi-colored design, add additional plastisol mold transfer compound to the appropriate areas of the mold. After each color is added, place the mold on the industrial hot plate to gel the mold compound as described above. Once all of the colors have been added to the mold and gelled, the mold can then be applied to a garment, such as a t-shirt.

Place the garment on an Insta Graphic Systems, Inc. MS203Z heat transfer machine, making sure to smooth out any wrinkles. For the best results, the garment should be pulled over the lower platen or the garment placement platen to prevent making an image of the mold on the back or front sides of the garment, depending on the application side of the mold. Place the mold, once it is cool enough to handle, on the desired area of the garment with the interior side or design side of the mold facing the garment. Align the garment on the heat transfer machine preferably over a silicone pad cut slightly larger than the mold. A silicone slip sheet may be placed over the mold to help protect the heat platen from being scratched and to prevent the back of the mold from sticking to the heat platen. Once the mold is lined up and the slip sheet is in place, bring the heat transfer platen down into contact with the mold. The temperature of the transfer press is set to a temperature of about 425 degrees F. Application time is about 15-20 seconds.

The pressure of a manual heat transfer machine may be set using the following procedure. With the mold placed on the pad of the transfer machine, bring the head down, and adjust the pressure setting until the head just barely contacts the mold. This is a low pressure setting and may at first seem to be too light a pressure. This is the correct setting as only the mold's edges will press into the pad and garment. Some experimentation may be required to determine the proper pressure setting. A pressure of between 20 psi and 50 psi is preferred.

After the mold is applied to the textile or garment, carefully remove the garment from the heat transfer machine and move to an Insta Graphic Systems, Inc. MACP1515 cool press machine to finish the application process. Once the garment and applied mold is placed on the lower platen of the cool press machine, bring the upper platen or head down on the mold and garment. Pressure should be the same as used on the heat transfer machine. The time under the cool down head is about 15-20 seconds. After 15-20 seconds, remove the garment and mold from the cool press machine and peel the mold from the garment.

Although the present invention has been described in considerable detail with reference to certain preferred versions thereof, other versions of the invention are possible. Therefore, the scope of the appended claims should not be limited to the description of the preferred versions contained herein.

What is claimed is:

1. A method for transferring a molded element onto a textile material comprising the steps of:
(a) heating a liquid polymeric material inside a mold at an effective temperature and for an effective time period to transform the liquid polymeric material from a liquid to a gel to form a molded element;
(b) applying the molded element in the mold to the textile material with heat and pressure at an effective temperature and pressure for an effective time period in order to transfer the molded element from the mold onto the textile material; and,
(c) cooling the molded element on the textile material by applying cold and pressure at an effective temperature and pressure for an effective time period to the molded element in the mold in order to adhere the molded element to the textile material.

2. The method of claim 1 further comprising the step after step (a) and before step (b) of cooling the molded element in the mold on a cold surface to an ambient temperature.

3. The method of claim 1 further comprising the steps after step (a) and before step (b) of cooling the molded element in the mold on a cold surface to an ambient temperature, adding another liquid polymeric material to the molded element in the mold, and repeating step (a).

4. The method of claim 1 wherein the liquid polymeric material comprises a plastisol compound.

5. The method of claim 4 wherein the plastisol compound comprises polyvinyl chloride resin, plasticizers, and additives.

6. The method of claim 5 wherein the plasticizers comprise phthalate esters, non-phthalate esters, or a combination of phthalate esters and non-phthalate esters.

7. The method of claim 5 wherein the additives comprise heat stabilizers and viscosity modifiers.

8. The method of claim 1 wherein the effective temperature for heating in steps (a) and (b) is at least 400 degrees F.

9. The method of claim 1 wherein the effective time period for heating in steps (a) and (b) is in the range of 10 seconds to 30 seconds.

10. The method of claim 1 wherein the effective pressure in steps (b) and (c) is in the range of 20 psi to 50 psi.

11. The method of claim 1 wherein the effective temperature in step (c) is ambient temperature or less than ambient temperature.

12. The method of claim 1 wherein the effective time period for cooling in step (c) is in the range of 10 seconds to 30 seconds.

13. The method of claim 1 wherein the liquid polymeric material in step (a) is heated in the mold on a hot plate.

14. The method of claim 1 wherein the molded element in step (b) is heated by a heat transfer apparatus having a heating power of 1200 watts or more and having a silicone pad positioned underneath the textile material.

15. The method of claim 1 wherein the molded element in step (c) is cooled by a cool press apparatus.

16. A method for transferring a three-dimensional image onto a fabric comprising the steps of:
(a) providing a hollow medium having an interior side and an exterior side;
(b) filling the interior side of the hollow medium with a liquid polymeric material;
(c) heating the liquid polymeric material inside the hollow medium to an effective temperature and for an effective time period to gel the liquid polymeric material and to form the three-dimensional image;
(d) applying the three-dimensional image in the hollow medium to the fabric with heat and pressure at an effective temperature and pressure for an effective time period to transfer the three-dimensional image from the hollow medium onto the fabric; and,
(e) cooling the three-dimensional image on the fabric by applying cold and pressure at an effective temperature and pressure for an effective time period to adhere the three-dimensional image in the hollow medium to the fabric.

17. The method of claim 16 further comprising the step after step (c) and before step (d) of cooling the three-dimensional image in the hollow medium on a cold surface to an ambient temperature.

18. The method of claim 16 further comprising the steps after step (c) and before step (d) of cooling the three-dimensional image in the hollow medium on a cold surface to an ambient temperature, adding another liquid polymeric material to the three-dimensional image in the hollow medium, and repeating step (c).

19. The method of claim 16 wherein the hollow medium comprises molds, photo etches, engravings, embossings, and dies.

20. A system for transferring a molded image onto a textile material comprising the steps of:
(a) heating on a heated surface a liquid polymeric material inside a mold to a temperature of at least 400 degrees F. and for an effective time period to transform the liquid polymeric material from a liquid to a gel to form a molded image;
(b) removing the molded image in the mold from the heated surface and cooling the molded image in the mold on a cold surface to an ambient temperature;
(c) applying the molded image to the textile material with a heat transfer apparatus at a temperature of at least 400 degrees F. and at an effective pressure for an effective time period to transfer the molded image from the mold onto the textile material; and,
(d) cooling the molded image on the textile material with a cool press apparatus at an effective temperature and pressure for an effective time period to adhere the molded image in the mold to the textile material.
